(19) United States
(12) Patent Application Publication
(10) Pub. No.: US 2026/0359099 A1
(43) Pub. Date: Nov. 12, 2026

(54) SYSTEM ON CHIP SUPPORTING TASK SCHEDULING, TASK SCHEDULING METHOD, MEDIUM, AND DEVICE

(71) Applicant: Horizon Journey (Shanghai) Technology Co., Ltd., Shanghai (CN)

(72) Inventor: Jianbing HU, Shanghai (CN)

(73) Assignee: Horizon Journey (Shanghai) Technology Co., Ltd., Shanghai (CN)

(21) Appl. No.: 19/747,907

(22) Filed: Jul. 20, 2026

(30) Foreign Application Priority Data
Sep. 1, 2025 (CN) 2025112423912

(51) Int. Cl. G06F 9/48

(52) U.S. Cl. CPC G06F 9/4825; G06F 9/4881

(57) ABSTRACT

Embodiments of the present disclosure disclose a system on chip supporting task scheduling, a task scheduling method, a medium, and a device. The system on chip includes: a processor, configured to determine a task set to be executed by the system on chip, determine a first accelerator in the system on chip that is capable of executing a first task in the task set, and determine first scheduling information for the first accelerator to execute the first task; and a first task scheduler for scheduling the first accelerator, configured to obtain the first scheduling information from the processor; control, based on the first scheduling information, a gated clock corresponding to the first accelerator to switch from an off state to an on state; and schedule the first accelerator to execute the first task.

### CROSS-REFERENCE TO RELATED APPLICATION

This application claims priority to Chinese Patent Application No. 202511242391.2 filed on Sep. 1, 2025, the entirety of which is incorporated herein by reference.

### FIELD

The present disclosure relates to technologies of integrated circuits, and in particular, to a system on chip supporting task scheduling, a task scheduling method, a medium, and a device.

### BACKGROUND

A system on chip (SoC for short, or referred to as a system-level chip) of an advanced driver assistance system or an intelligent cockpit system of a vehicle and a system on chip of a terminal device such as a mobile phone typically include a central processing unit (CPU for short) and some hardware accelerators (or referred to as task processing circuits). The accelerators may include, for example, a graphics processing unit (GPU for short), a neural network processing unit (NPU for short), and an image signal processor (ISP for short). In related technologies, the CPU is typically used to schedule the accelerators to execute corresponding tasks, resulting in relatively large dynamic power consumption of the accelerators. How to effectively regulate the dynamic power consumption of the accelerators has become a technical problem that urgently needs to be resolved.

### SUMMARY

Embodiments of the present disclosure provide a system on chip supporting task scheduling, a task scheduling method, a medium, and a device, so as to reduce dynamic power consumption of accelerators, thereby reducing total power consumption of a system on chip.

According to a first aspect of an embodiment of the present disclosure, a system on chip supporting task scheduling is provided, including: a processor, configured to determine a task set to be executed by the system on chip, determine a first accelerator in the system on chip that is capable of executing a first task in the task set, and determine first scheduling information for the first accelerator to execute the first task; and a first task scheduler for scheduling the first accelerator, configured to obtain the first scheduling information from the processor; control, based on the first scheduling information, a gated clock corresponding to the first accelerator to switch from an off state to an on state; and schedule the first accelerator to execute the first task.

According to a second aspect of an embodiment of the present disclosure, a task scheduling method is provided, including: determining a task set to be executed by a system on chip; determining a first accelerator in the system on chip that is capable of executing a first task in the task set; determining first scheduling information for the first accelerator to execute the first task; and controlling, based on the first scheduling information by a first task scheduler corresponding to the first accelerator, a gated clock corresponding to the first accelerator to switch from an off state to an on state, and scheduling the first accelerator to execute the first task.

According to a third aspect of an embodiment of the present disclosure, a computer readable storage medium is provided. The storage medium stores a computer program, and the computer program is executed by a processor to implement the task scheduling method according to any one of the foregoing embodiments of the present disclosure.

According to a fourth aspect of an embodiment of the present disclosure, an electronic device is provided. The electronic device includes the system on chip according to any one of the foregoing embodiments of the present disclosure.

According to a fifth aspect of an embodiment of the present disclosure, an electronic device is provided. The electronic device includes: a processor; and a memory, configured to store instructions executable by the processor. The processor is configured to read the executable instructions from the memory, and execute the executable instructions to implement the task scheduling method according to any one of the foregoing embodiments.

According to a sixth aspect of an embodiment of the present disclosure, a computer program product is provided. When instructions in the computer program product are executed by a processor, the task scheduling method according to any one of the foregoing embodiments of the present disclosure is implemented.

According to the system on chip supporting task scheduling, the task scheduling method, the medium, and the device that are provided in the foregoing embodiments of the present disclosure, the processor determines the task set to be executed by the system on chip, determines the first accelerator in the system on chip that is capable of executing the first task in the task set, and determines the first scheduling information for the first accelerator to execute the first task. Further, the first task scheduler obtains the first scheduling information from the processor, and controls, based on the first scheduling information, the gated clock corresponding to the first accelerator to switch from the off state to the on state, so that the first task scheduler can schedule the first accelerator to execute the first task. Since the first accelerator is scheduled by a hardware task scheduler, compared with scheduling the accelerator through CPU software, an execution speed of the hardware task scheduler is far greater than a software scheduling speed. For example, a granularity of task scheduling may be reduced from a microsecond level to a nanosecond level, and the gated clock of the first accelerator can be controlled in a real-time manner based on tasks. When the first accelerator needs to execute a task, the gated clock corresponding to the first accelerator is controlled to switch from the off state to the on state. In other words, when the first accelerator is not executing a task, the gated clock corresponding to the first accelerator is in the off state, which avoids power consumption of the first accelerator when not executing a task. Thus, dynamic power consumption of the accelerator in the system on chip can be reduced, thereby reducing total power consumption of the system on chip.

### BRIEF DESCRIPTION OF THE DRAWINGS

FIG. 1 is an exemplary application scenario of a system on chip supporting task scheduling according to the present disclosure;

FIG. 2 is a schematic diagram of a structure of a system on chip supporting task scheduling according to an exemplary embodiment of the present disclosure;

FIG. 3 is a schematic diagram of a structure of a system on chip supporting task scheduling according to another exemplary embodiment of the present disclosure;

FIG. 4 is a schematic diagram of a structure of a system on chip supporting task scheduling according to still another exemplary embodiment of the present disclosure;

FIG. 5 is a schematic diagram of a structure of a system on chip supporting task scheduling according to yet another exemplary embodiment of the present disclosure;

FIG. 6 is a schematic diagram of a structure of a system on chip supporting task scheduling according to still yet another exemplary embodiment of the present disclosure;

FIG. 7 is a schematic diagram of a structure of a system on chip supporting task scheduling according to a further exemplary embodiment of the present disclosure;

FIG. 8 is a schematic diagram of a structure of a system on chip supporting task scheduling according to a still further exemplary embodiment of the present disclosure;

FIG. 9 is a schematic diagram of a task set according to an exemplary embodiment of the present disclosure;

FIG. 10 is a schematic flowchart of a task scheduling method according to an exemplary embodiment of the present disclosure; and

FIG. 11 is a diagram of a structure of an electronic device according to an embodiment of the present disclosure.

### DETAILED DESCRIPTION

To explain the present disclosure, exemplary embodiments of the present disclosure are described below in detail with reference to accompanying drawings. Obviously, the embodiments described are merely some, rather than all of embodiments of the present disclosure. It should be understood that the present disclosure is not limited by the exemplary embodiments.

It should be noted that, unless otherwise specifically stated, the relative arrangement of components and steps, numerical expressions, and numerical values set forth in these embodiments do not limit the scope of the present disclosure.

### Overview of Disclosure

In a process of implementing the present disclosure, the inventors finds that a system on chip (SoC for short, or referred to as a system-level chip) of an advanced driver assistance system or an intelligent cockpit system of a vehicle and a system on chip of a terminal device such as a mobile phone typically include a central processing unit (CPU for short) and some hardware accelerators (or referred to as task processing circuits). The accelerators may include, for example, a graphics processing unit (GPU for short), a neural network processing unit (NPU for short), and an image signal processor (ISP for short). In related technologies, the CPU is typically used to schedule the accelerators to execute corresponding tasks. The accelerators are in a working state when executing tasks and in an idle state when not executing tasks. Although power consumption of the accelerators in the idle state is lower than that in the working state, there is still a certain amount of power consumption. Taking image processing as an example, if 24 frames of images need to be processed per second, and during processing of each frame of image, a task that needs to be executed by calling the accelerator takes 1 millisecond, within 1 second, the accelerator is in the working state for only 24 milliseconds and is in the idle state for the rest of the time, resulting in relatively large dynamic power consumption of the accelerator, and relatively large total power consumption of the system on chip. How to effectively regulate the dynamic power consumption of the accelerators and reduce the total power consumption of the system on chip has become a technical problem that urgently needs to be resolved.

Exemplary Overview

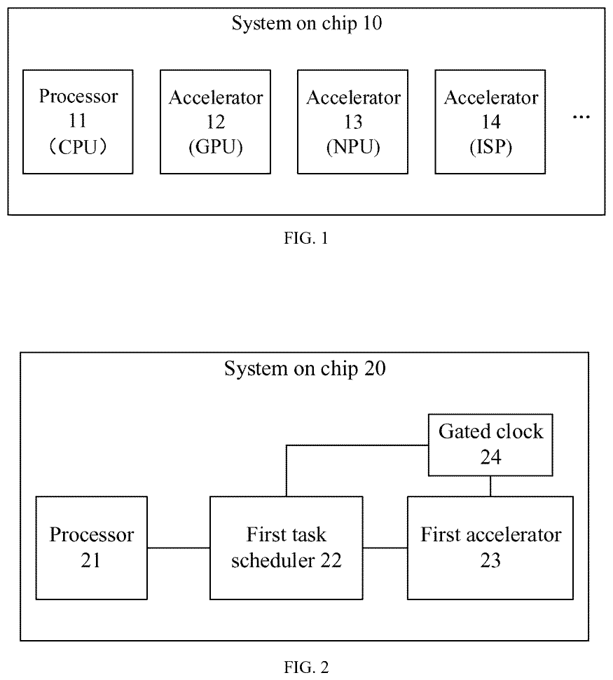

FIG. 1 is an exemplary application scenario of a system on chip supporting task scheduling according to the present disclosure. As shown in FIG. 1, in an intelligent driving scenario, a system on chip 10 may include a processor (that is, a CPU) 11 and at least one accelerator. The at least one accelerator is, for example, an accelerator 12, an accelerator 13, an accelerator 14, . . . shown in FIG. 1. The accelerator 12 may be a GPU, the accelerator 13 may be an NPU, and the accelerator 14 may be an ISP. The processor 11 may run software programs corresponding to various functions related to intelligent driving. The functions related to intelligent driving may include, but are not limited to, a perception function, a localization function, and a planning and control function. During the running of the software programs, tasks requiring acceleration processing by accelerators, such as various to-be-accelerated tasks related to neural network model inference, may be generated. By using the system on chip supporting task scheduling in embodiments of the present disclosure, on the basis of a structure shown in FIG. 1, task schedulers for scheduling the accelerators can be provided. The task schedulers are respectively coupled to the processor 11 and an accelerator 1i, where i=2, 3, . . . . The processor 11 may determine a task set to be executed by the system on chip, determine a first accelerator in the system on chip that is capable of executing a first task in the task set, and determine first scheduling information for the first accelerator to execute the first task. For example, the first accelerator is the accelerator 12. A first task scheduler for scheduling the first accelerator obtains the first scheduling information from the processor 11; controls, based on the first scheduling information, a gated clock corresponding to the first accelerator to switch from an off state to an on state; and schedules the first accelerator to execute the first task. Since the first accelerator is scheduled by a hardware task scheduler, compared with scheduling the accelerator through CPU software, an execution speed of the hardware task scheduler is far greater than a software scheduling speed. For example, a granularity of task scheduling may be reduced from a microsecond level to a nanosecond level, and the gated clock of the first accelerator can be controlled in a real-time manner based on tasks. When the first accelerator needs to execute a task, the gated clock corresponding to the first accelerator is controlled to switch from the off state to the on state. In other words, when the first accelerator is not executing a task, the gated clock corresponding to the first accelerator is in the off state, which avoids power consumption of the first accelerator when not executing a task. Thus, dynamic power consumption of the accelerator in the system on chip can be reduced, thereby reducing total power consumption of the system on chip.

### Exemplary System

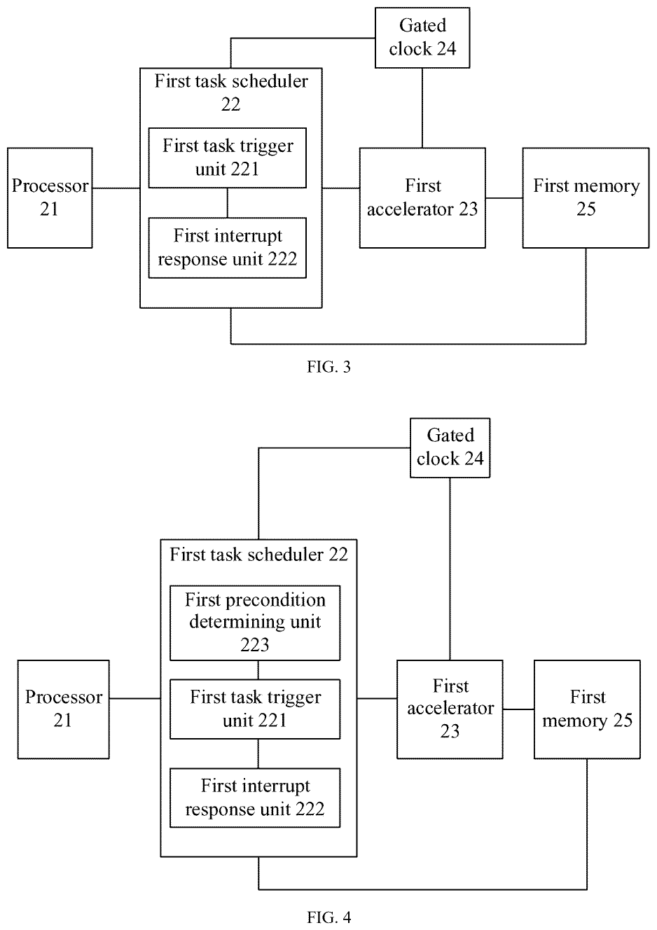

FIG. 2 is a schematic diagram of a structure of a system on chip supporting task scheduling according to an exemplary embodiment of the present disclosure. The system on chip supporting task scheduling (which may be referred to as a system on chip or a system for short) provided in this embodiment may be applied to an electronic device. The electronic device may include, but is not limited to, a vehicle-mounted computing platform (or referred to as a vehicle-mounted terminal), a mobile phone, and a smart wearable device. As shown in FIG. 2, a system on chip 20 in this embodiment of the present disclosure may include a processor 21 and a first task scheduler 22. The first task scheduler 22 is respectively coupled to the processor 21 and a first accelerator 23, and is configured to schedule the first accelerator 23.

The processor 21 is configured to determine a task set to be executed by the system on chip 20, determine the first accelerator 23 in the system on chip 20 that is capable of executing a first task in the task set, and determine first scheduling information for the first accelerator 23 to execute the first task.

The first task scheduler 22 is configured to obtain the first scheduling information from the processor 21; control, based on the first scheduling information, a gated clock 24 corresponding to the first accelerator 23 to switch from an off state to an on state; and schedule the first accelerator 23 to execute the first task.

The first task scheduler 22 is also coupled to the gated clock 24 corresponding to the first accelerator 23.

In some optional embodiments, the processor 21 may be a CPU, configured to determine the task set to be executed by the system on chip 20. The task set may include at least one task. If the task set includes a plurality of tasks, the plurality of tasks may have certain dependency relationships therebetween. The first task may be any task in the task set. The task set may be pre-compiled by a compiler and stored in a memory. When the task set needs to be executed, the processor 21 may read the task set from the memory. For example, the task set includes tasks respectively corresponding to at least one operator in a neural network model.

In some optional embodiments, the tasks in the task set may include, but are not limited to, one or more of an image processing task, an audio processing task, and a data computation task. The dependency relationships indicate an execution sequence of the tasks in the task set.

In some optional embodiments, the system on chip 20 may include at least one accelerator. Any accelerator is capable of executing specific tasks. For example, the at least one accelerator may include, but is not limited to, an image processing accelerator, an audio processing accelerator, a data computation accelerator, and a neural network processor. The image processing accelerator is capable of executing an image processing task, the audio processing accelerator is capable of executing an audio processing task, the data computation accelerator is capable of executing a data computation task, and the neural network processor is capable of executing a computation task related to a neural network operator.

In some optional embodiments, any accelerator may include hardware acceleration units capable of implementing various specific computation functions, such as a tensor processing unit (TPU for short) and a scalar processing unit. The processor 21 may determine, based on a task type of the first task and task types that can be supported by the accelerators, the first accelerator 23 capable of executing the first task.

In some optional embodiments, the first scheduling information is scheduling information required by the first task scheduler 22 to schedule the first accelerator 23. The first scheduling information may include, but is not limited to, one or more of task information, dependency information, and depended-upon information of the first task. The task information refers to information required for executing the first task. The information required for executing the first task may include, but is not limited to, a task identifier and a computation parameter of the first task. The dependency information refers to information about a predecessor task (or referred to as an anteriorly associated task) on which the first task depends. The depended-upon information refers to information about a successor task (or referred to as a posteriorly associated task) that depends on the first task. For example, the first scheduling information may include a task identifier of the predecessor task and a task identifier of the successor task of the first task. The task identifier is information that uniquely identifies a task in the task set. Optionally, if the first task can be executed without depending on other tasks in the task set, the information about the predecessor task of the first task may be preset information, for example, may be empty and marked as null. If the first task is not depended upon by other tasks in the task set, the information about the successor task of the first task may be preset information.

In some optional embodiments, the first scheduling information for the first task may be determined based on the dependency relationships among the tasks in the task set.

In some optional embodiments, after determining the first scheduling information for the first accelerator 23 to execute the first task, the processor 21 transmits the first scheduling information to the first task scheduler 22 corresponding to the first accelerator 23.

In some optional embodiments, the processor 21 may transmit the first scheduling information in a form of a data packet. The data packet corresponding to the first scheduling information may include a header portion and a data portion. The header portion may include, but is not limited to, one or more of a data length, a source, a destination, a task type, and an associated task. The data length refers to an overall data length of the data packet. The source and the destination respectively indicate a sender and a receiver of the first scheduling information. The source may be an address corresponding to the processor 11, and the destination may be an address corresponding to the first task scheduler 22. The task type indicates a type of the first task to be executed. The associated task is a task associated with the first task, and may include a predecessor task anteriorly associated with the first task and a successor task posteriorly associated with the first task. The data portion may include, but is not limited to, one or more of a task identifier, a static parameter, a dynamic parameter, and other related parameters. The task identifier may be a number of the first task in the task set. The static parameter is a static computation parameter required for executing the task. The dynamic parameter is a dynamic computation parameter required for executing the task. The static parameter may include, but is not limited to, a storage address of static computation data. The dynamic parameter may include, but is not limited to, a storage address of dynamic computation data. The static computation data is pre-obtained computation data, such as weight data of the neural network model. The dynamic computation data is dynamically changing computation data. For example, input data of the task is dynamically determined. For example, feature data in an inference process of the neural network model is determined based on images, audio, and the like that are collected in a real-time manner. The processor 21 generates a data packet corresponding to the first scheduling information according to a data packet format, and transmits the data packet to the first task scheduler 22.

In some optional embodiments, if the first task is a first task in the task set or there is no predecessor task in the task set on which the first task depends, the first scheduling information for the first task may include a static parameter and a dynamic parameter required for executing the first task, and the first task scheduler 22 may determine input data of the first task based on the dynamic parameter. If the first task is not the first task in the task set and there is a predecessor task in the task set on which the first task depends, the first task scheduler 22 may also obtain an execution result of the predecessor task of the first task, and schedule the first accelerator 23 based on the first scheduling information and the execution result of the predecessor task. For example, the first task scheduler 22 may obtain second scheduling information for the first task from a task scheduler corresponding to the predecessor task. The second scheduling information includes a storage address of the execution result of the predecessor task. The first task scheduler 22 may schedule, based on the first scheduling information and the second scheduling information required for executing the first task, the first accelerator 23 to execute the first task.

In some optional embodiments, the first task scheduler 22 is a hardware circuit capable of scheduling the first accelerator 23.

In some optional embodiments, the first task scheduler 22, in response to obtaining the first scheduling information from the processor 21, controls the gated clock 24 corresponding to the first accelerator 23 to switch from the off state to the on state. The gated clock 24 corresponding to the first accelerator 23 is a hardware circuit for controlling on or off of a clock signal. When the gated clock 24 is in the off state, the clock signal is blocked, so as to avoid toggling of a register in the first accelerator 23 and a switching activity of combinational logic. When the gated clock 24 is in the on state, the clock signal is normally transmitted, and the register in the first accelerator 23 toggles periodically to update data, thereby ensuring that the first accelerator 23 can operate normally.

In some optional embodiments, the first task scheduler 22 may switch the gated clock 24 from the off state to the on state by controlling an enable signal (EN) of the gated clock 24 to switch from a non-enabled state to an enabled state. For example, the non-enabled state is EN=0, and the enabled state is EN=1. After the gated clock 24 switches from the off state to the on state, the first accelerator 23 can operate normally, and the first task scheduler 22 may schedule, based on the first scheduling information, the first accelerator 23 to execute the first task.

In some optional embodiments, when the first task scheduler 22 schedules the first accelerator 23, if the predecessor task of the first task is null, the first task scheduler 22 may directly schedule the first accelerator 23 based on the first scheduling information. If the predecessor task of the first task is not null, the first task scheduler 22 may obtain the execution result of the predecessor task of the first task, and then schedule the first accelerator 23 based on the first scheduling information and the execution result of the predecessor task.

In some optional embodiments, the first task scheduler 22 may configure, based on the first scheduling information, configuration information (or referred to as first configuration information) required for the first accelerator 23 to execute the first task. The first accelerator 23 obtains computation data based on the first configuration information, and performs computation based on the computation data, to obtain the execution result of the first task. The first accelerator 23 may transmit the execution result of the first task to the first task scheduler 22, and/or store the execution result in a storage area corresponding to the first task. The first configuration information may include, but is not limited to, various parameters required for executing the first task. The various parameters include, but are not limited to, computation data or a storage address of the computation data, a computation type, and a storage address of computation results.

In some optional embodiments, the first task scheduler 22 may be implemented by one or more of hardware logic circuits such as a controller, a register, a comparator, a communication interface, and a selector. A specific implementation manner is not limited.

According to the system on chip supporting task scheduling provided in the embodiments, since the first accelerator is scheduled by a hardware task scheduler, compared with scheduling the accelerator through CPU software, an execution speed of the hardware task scheduler is far greater than a software scheduling speed. For example, a granularity of task scheduling may be reduced from a microsecond level to a nanosecond level, and the gated clock of the first accelerator can be controlled in a real-time manner based on tasks. When the first accelerator is not executing a task, the gated clock corresponding to the first accelerator is in the off state. When the first accelerator needs to execute a task, the gated clock corresponding to the first accelerator is controlled to switch from the off state to the on state, so that the first accelerator has no power consumption when not executing a task. Thus, dynamic power consumption of the accelerator in the system on chip can be effectively reduced, thereby reducing total power consumption of the system on chip.

FIG. 3 is a schematic diagram of a structure of a system on chip supporting task scheduling according to another exemplary embodiment of the present disclosure.

In some optional embodiments, on the basis of the embodiments shown in FIG. 2, as shown in FIG. 3, the first task scheduler 22 includes a first task trigger unit 221 and a first interrupt response unit 222.

The first task trigger unit 221 is respectively coupled to the processor 21, the first accelerator 23, and the gated clock 24, and is configured to obtain the first scheduling information, determine the first configuration information corresponding to the first task based on the first scheduling information, switch the gated clock 24 corresponding to the first accelerator 23 from the off state to the on state, and transmit the first configuration information to the first accelerator 23.

The first accelerator 23 is configured to execute the first task based on the first configuration information to obtain a first processing result corresponding to the first task, write the first processing result into a first memory 25, and generate a first interrupt signal in response to completion of execution of the first task.

The first interrupt response unit 222 is respectively coupled to the first accelerator 23, the gated clock 24, and the first memory 25, and is configured to, in response to the first interrupt signal from the first accelerator 23, perform interrupt processing corresponding to the first interrupt signal, read the first processing result from the first memory 25, and control the gated clock corresponding to the first accelerator 23 to switch from the on state to the off state.

The first task trigger unit 221 and the first interrupt response unit 222 are hardware circuits. The first configuration information corresponding to the first task is configuration information required by the first accelerator 23 to execute the first task. The first configuration information may include, but is not limited to, various parameters required for executing the first task. The various parameters may include, but are not limited to, computation data or a storage address of the computation data, a computation type, and a storage address of computation results.

In some optional embodiments, the first task trigger unit 221 obtains the first scheduling information from the processor 21; parses the first scheduling information to obtain the task information, the dependency information, and the depended-upon information of the first task; and determines the first configuration information based on the task information and the dependency information that are obtained through parsing.

In some optional embodiments, the operations of determining the first configuration information and controlling the gated clock 24 corresponding to the first accelerator 23 to switch from the off state to the on state are not executed in a sequential order.

In some optional embodiments, after determining the first configuration information, the first task trigger unit 221 may transmit the first configuration information to the first accelerator 23. The first accelerator 23 writes the first configuration information into a configuration register, and triggers execution of the first task. The first accelerator 23 reads the first configuration information from the configuration register, obtains the computation data based on the first configuration information, and performs computation on the computation data, to obtain the execution result of the first task. The execution result is the first processing result corresponding to the first task. The first accelerator 23 writes the first processing result into the first memory 25. The first memory 25 is any type of pre-configured memory capable of storing execution results of tasks.

In some optional embodiments, if the execution of the first task is completed, the first accelerator 23 generates the first interrupt signal and transmits the first interrupt signal to the first interrupt response unit. The first interrupt signal indicates an interrupt request issued by the first accelerator 23 after completing the execution of the first task, to notify the first task scheduler 22 or the first interrupt response unit 222 that the execution of the first task is completed. The first interrupt response unit 222, in response to the first interrupt signal from the first accelerator 23, performs interrupt processing corresponding to the first interrupt signal, that is, reads the first processing result corresponding to the first task from the first memory 25; and controls the gated clock corresponding to the first accelerator 23 to switch from the on state to the off state.

In some optional embodiments, after the first interrupt response unit 222 reads the first processing result corresponding to the first task, the first task scheduler 22 may transmit, based on a position of the first task among the tasks in the task set, the first processing result to the processor 21, and/or store the first processing result in a preset storage space, and/or schedule a next task based on the first processing result. If the first task is a last task in the task set, and the first processing result of the first task is a final processing result of the task set, the first interrupt response unit 222 may transmit the first processing result to the processor 21 and/or store the first processing result in a preset storage space accessible by the processor 21. The processor 21 may obtain the first processing result from the first interrupt response unit 222, or read the first processing result from the preset storage space. After obtaining the first processing result, the processor 21 may continue to determine a next task set or execute another task. If the first task is not the last task in the task set, the first task scheduler 22 or the first interrupt response unit 222 may schedule a next task based on the first processing result. For example, the first task scheduler 22 or the first interrupt response unit 222 may schedule a task scheduler corresponding to the next task, and an accelerator capable of executing the next task is scheduled by the task scheduler corresponding to the next task.

In some optional embodiments, the first interrupt response unit 222 may implement interrupt processing by executing a pre-compiled interrupt processing instruction. Accelerating the interrupt processing through hardware improves interrupt processing efficiency. The interrupt processing instruction is an instruction that is obtained by compiling an interrupt processing program (or referred to as an interrupt processing function) of software based on a compiler, and can be executed by the first interrupt response unit 222. In other words, the interrupt processing instruction is an instruction that can be executed by hardware.

In the embodiments of the present disclosure, the first task trigger unit generates the first configuration information of the first task based on the first scheduling information, switches the gated clock corresponding to the first accelerator executing the first task from the off state to the on state, and transmits the first configuration information to the first accelerator. In this way, the triggering of the task is implemented through hardware, the first configuration information provides effective information reference for the first accelerator to execute the first task, and the state switching of the gated clock ensures that the first accelerator can accurately execute the first task. Moreover, after the first accelerator completes the execution of the first task, the interrupt request of the first accelerator is responded to through the first interrupt response unit, avoiding interruption of a program being executed by the processor 21. Since the first interrupt response unit is a hardware circuit, compared with the processor 21 responding to the interrupt request through software, responding to the interrupt request through hardware can improve interrupt processing efficiency. In addition, after the execution of the first task is completed, the first interrupt response unit promptly controls the gated clock of the first accelerator to switch from the on state to the off state, which can further reduce dynamic power consumption of the first accelerator.

FIG. 4 is a schematic diagram of a structure of a system on chip supporting task scheduling according to still another exemplary embodiment of the present disclosure.

In some optional embodiments, as shown in FIG. 4, the first task scheduler 22 further includes a first precondition determining unit 223.

The first precondition determining unit 223 is respectively coupled to the processor 21 and the first task trigger unit 221, and is configured to obtain the first scheduling information, and determine a trigger state of the first task based on the first scheduling information.

The first task trigger unit 221 is configured to obtain the trigger state of the first task from the first precondition determining unit 223; and in response to the trigger state of the first task being triggered, obtain the first scheduling information, determine the first configuration information based on the first scheduling information, switch the gated clock 24 corresponding to the first accelerator 23 from the off state to the on state, and transmit the first configuration information to the first accelerator 23.

The first precondition determining unit 223 is a hardware circuit. The trigger state of the first task indicates whether the first task can be triggered, and may include two states: triggered and not triggered. The trigger state of the first task may be determined based on the dependency information of the first task in the first scheduling information. If it is determined based on the first scheduling information that there is a predecessor task in the task set on which the first task depends, the trigger state of the first task is determined based on a completion state of the predecessor task. If there is at least one predecessor task of which execution is not completed, the trigger state of the first task is determined to be not triggered. If execution of all predecessor tasks of the first task is completed, or there is no predecessor task of the first task in the task set, the trigger state of the first task is determined to be triggered.

In some optional embodiments, after determining the trigger state of the first task, the first precondition determining unit 223 transmits the trigger state of the first task to the first task trigger unit 221, which obtains the trigger state of the first task from the first precondition determining unit 223. If the trigger state of the first task is triggered, the first task trigger unit 221 triggers the first task. To be specific, the first task trigger unit 221 obtains the first scheduling information, determines the first configuration information based on the first scheduling information, switches the gated clock 24 corresponding to the first accelerator 23 from the off state to the on state, and transmits the first configuration information to the first accelerator 23.

In the embodiments of the present disclosure, the first precondition determining unit determines the trigger state of the first task based on the first scheduling information. The gated clock of the first accelerator is switched from the off state to the on state merely in a case where the trigger state of the first task is determined to be triggered, so that the first accelerator can execute the first task. Thus, accuracy of state switching timing of the gated clock can be further improved, so that the gated clock can be prevented from being prematurely switched from the off state to the on state, thereby further reducing the dynamic power consumption of the first accelerator.

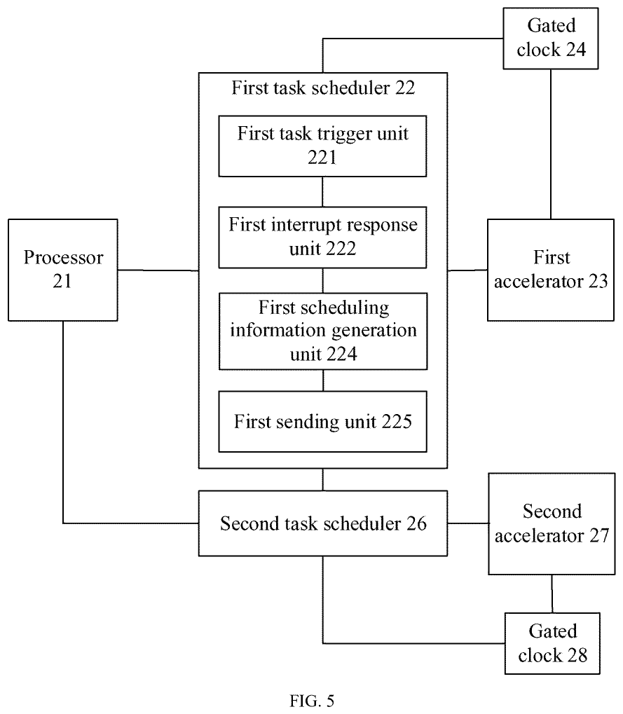

FIG. 5 is a schematic diagram of a structure of a system on chip supporting task scheduling according to yet another exemplary embodiment of the present disclosure.

In some optional embodiments, as shown in FIG. 5, the first task scheduler 22 further includes a first scheduling information generation unit 224 and a first sending unit 225.

The first scheduling information generation unit 224 is coupled to the first interrupt response unit 222, and is configured to obtain the first processing result; and determine, based on the first processing result and the first scheduling information, a second task posteriorly associated with the first task, and a second task scheduler 26 and second scheduling information corresponding to the second task.

The first sending unit 225 is coupled to the first scheduling information generation unit 224, and is configured to obtain the second scheduling information, and transmit the second scheduling information to the second task scheduler 26. The second task scheduler 26 is a task scheduler corresponding to a second accelerator 27 capable of executing the second task.

The second task scheduler 26 is coupled to the first task scheduler 22, and is configured to control, based on the second scheduling information, a gated clock 28 corresponding to the second accelerator 27 to switch from an off state to an on state, and schedule the second accelerator 27 to execute the second task.

The first scheduling information generation unit 224 and the first sending unit 225 are hardware circuits. The second task posteriorly associated with the first task refers to a task in the task set that depends on the first task. In other words, the second task is a successor task of the first task.

In some optional embodiments, after obtaining the first processing result, the first interrupt response unit 222 may transmit the first processing result or a storage address of the first processing result to the first scheduling information generation unit 224. The first scheduling information generation unit 224 may obtain the first processing result from the first interrupt response unit 222, or read the first processing result from a preset storage space based on the storage address of the first processing result from the first interrupt response unit 222. After obtaining the first processing result, the first scheduling information generation unit 224 determines, based on the first processing result and the first scheduling information, the second task posteriorly associated with the first task, and the second task scheduler 26 and the second scheduling information corresponding to the second task. The second task scheduler 26 corresponding to the second task is a task scheduler capable of scheduling the second accelerator 27 to execute the second task. Similar to the first task scheduler 22, the second task scheduler 26 is a hardware circuit. The second scheduling information is information required by the second task scheduler 26 to schedule the second accelerator 27. The second scheduling information may include, but is not limited to, a task identifier and a dynamic parameter of the second task. The dynamic parameter of the second task is a dynamic computation parameter required for executing the second task. For example, the dynamic parameter may include the storage address of the first processing result, and the first processing result is input data of the second task.

In some optional embodiments, after determining the second task, the second task scheduler 26, and the second scheduling information, the first scheduling information generation unit 224 may transmit the second scheduling information to the second task scheduler 26 through the first sending unit 225.

In some optional embodiments, the first scheduling information generation unit 224 may transmit the second scheduling information in a form of a data packet. The data packet corresponding to the second scheduling information may include a header portion and a data portion. The header portion may include, but is not limited to, a data length, a source, a destination, a task type, and an associated task. The data length refers to an overall data length of the data packet. The source and the destination respectively indicate a sender and a receiver of the second scheduling information. The source may be an address of the first task scheduler 22, and the destination may be an address of the second task scheduler 26. The task type indicates a type of the second task to be executed. The associated task is a task associated with the second task, and may include a predecessor task anteriorly associated with the second task and a successor task posteriorly associated with the second task. The data portion may include, but is not limited to, the task identifier, the dynamic parameter, and other related parameters of the second task. The task identifier may be a number of the second task in the task set. The dynamic parameter is the storage address of the first processing result of the first task. The first scheduling information generation unit 224 determines, based on the first processing result and the first scheduling information, the information required for generating the data packet corresponding to the second scheduling information, packages the information into the data packet corresponding to the second scheduling information according to a data packet format, and transmits the data packet to the second task scheduler 26 through the first sending unit 225, thereby implementing transmission of the second scheduling information.

In some optional embodiments, data may be transmitted between the first task scheduler 22 and the second task scheduler 26 through any communication approach. For example, data may be transmitted through a bus or other approaches, which is not specifically limited.

In some optional embodiments, after obtaining the second scheduling information from the first task scheduler 22, the second task scheduler 26 controls, based on the second scheduling information, the gated clock 28 corresponding to the second accelerator 27 to switch from the off state to the on state, so that the second accelerator 27 can execute the second task. The second task scheduler may determine second configuration information corresponding to the second task based on the second scheduling information, and schedule, based on the second configuration information, the second accelerator 27 to execute the second task.

In some optional embodiments, the second task scheduler 26 is a task scheduler other than the first task scheduler 22. In other words, the second task scheduler 26 is not the first task scheduler 22. Optionally, the first task may include at least one subtask that can be executed by the first accelerator, and the second task may include at least one subtask that can be executed by the second accelerator. To be specific, according to a dependency relationship between the subtasks, at least one subtask executable by a same accelerator is taken as one task, which facilitates completion of the at least one subtask through single scheduling of the accelerator, and avoids consecutively scheduling the same accelerator for a plurality of times, thereby improving task scheduling efficiency.

In some optional embodiments, the second task scheduler 26 and the first task scheduler 22 may be a same task scheduler. For example, if a task type of the second task is same as that of the first task, the second task scheduler 26 and the first task scheduler 22 may be a same task scheduler. In this case, the first scheduling information generation unit 224 may be coupled to the first task trigger unit 221, or the first sending unit 225 may be coupled to the first task trigger unit 221. The first scheduling information generation unit 224 may transmit the second scheduling information to the first task trigger unit 221 in the first task scheduler 22, or may transmit the second scheduling information to the first task trigger unit 221 through the first sending unit 225, to trigger a processing flow of the second task. The specific processing flow of the second task is similar to that of the first task described above, and details are not described herein.

In the embodiments of the present disclosure, the first task scheduler determines the second task, and the second task scheduler and the second scheduling information corresponding to the second task through the first scheduling information generation unit, and transmits the second scheduling information to the second task scheduler through the first sending unit, so as to control, through the second task scheduler, the gated clock of the second accelerator to switch from the off state to the on state, and schedule the second accelerator to execute the second task. Thus, the scheduling of the second task scheduler is implemented through the first task scheduler, and the scheduling of the second accelerator is implemented through the second task scheduler. In other words, according to the present disclosure, the accelerators are scheduled through hardware to execute corresponding task processing, which can effectively avoid frequently interrupting a program being executed by the processor 21, thereby effectively improving task scheduling efficiency.

In some optional embodiments, the processor 21 is coupled to the second task scheduler 26, and is configured to determine third scheduling information for the second accelerator 27 to execute the second task.

The second task scheduler 26 is configured to: obtain the second scheduling information and the third scheduling information; control, based on the second scheduling information and the third scheduling information, the gated clock 28 corresponding to the second accelerator 27 to switch from the off state to the on state; and schedule the second accelerator 27 to execute the second task.

The third scheduling information for the second accelerator 27 to execute the second task is similar to the first scheduling information for the first accelerator 23 to execute the first task, and details are not described herein.

In some optional embodiments, the processor 21 may first determine the first scheduling information for the first task to be executed this time, and then determine the third scheduling information for the second task in a real-time manner when execution proceeds to the second task. Alternatively, the processor 21 may determine scheduling information for all tasks in the task set in a single pass. When the execution proceeds to a certain task, this task serves as the first task, and scheduling information therefor is the first scheduling information for the first task. When the execution proceeds to the second task, the scheduling information for the second task is the third scheduling information for the second task.

For example, when needing to obtain the final processing result of the task set, the processor 21 may respectively determine the scheduling information for the tasks in the task set, send the scheduling information for the tasks to the task schedulers corresponding to the tasks, or store the scheduling information in storage spaces accessible by the task schedulers. Subsequently, the processor 21 may execute other tasks outside the task set, and the tasks in the task set may be executed by scheduling corresponding accelerators by the respective task schedulers, until the tasks in the task set are completed. If all the tasks in the task set can be executed by accelerators, the processor 21 need not be interrupted to execute other tasks during the process. The task schedulers may obtain the scheduling information from the processor 21, or read the scheduling information from the storage spaces. For the second task, the second task scheduler 26 may obtain the scheduling information for the second task from the processor 21 or the storage space, to serve as the third scheduling information for the second task.

After scheduling the first accelerator 23 to complete the execution of the first task, the first task scheduler 22 generates the second scheduling information for the second task, and transmits the second scheduling information to the second task scheduler 26. The second task scheduler 26 may obtain the second scheduling information and read the stored third scheduling information. The second task scheduler 26 controls, based on the second scheduling information and the third scheduling information, the gated clock 28 corresponding to the second accelerator 27 to switch from the off state to the on state; and schedules the second accelerator 27 to execute the second task.

In some optional embodiments, the third scheduling information includes a static parameter and a task type required for executing the second task, and the second scheduling information includes a dynamic parameter required for executing the second task. The second task scheduler 26 configures, based on the second scheduling information and the third scheduling information, the dynamic parameter and the static parameter required by the second accelerator 27 to execute the second task. The second accelerator 27 executes the second task based on the parameters configured by the second task scheduler 26.

The specific operation of the second task scheduler 26 controlling the gated clock 28 corresponding to the second accelerator 27 to switch from the off state to the on state is similar in principle to the specific operation of the first task scheduler 22 controlling the gated clock 24 corresponding to the first accelerator 23 described above, and details are not described herein.

In the embodiments of the present disclosure, the second task scheduler obtains the second scheduling information generated by the first task scheduler and the third scheduling information generated by the processor, and schedules the second accelerator based on the second scheduling information and the third scheduling information. Since the third scheduling information includes the static parameter required for executing the second task and the second scheduling information includes the dynamic parameter required for executing the second task, the static parameter and the dynamic parameter required for the second accelerator to execute the second task can be provided, thereby ensuring that the second accelerator can effectively execute the second task.

In some optional embodiments, the first task scheduler 22 may include, but is not limited to, the first precondition determining unit 223, the first task trigger unit 221, the first interrupt response unit 222, the first scheduling information generation unit 224, and the first sending unit 225. The first task trigger unit 221 is coupled to the first precondition determining unit 223. The first interrupt response unit 222 is coupled to the first task trigger unit 221. The first scheduling information generation unit 224 is coupled to the first interrupt response unit 222. The first sending unit 225 is coupled to the first scheduling information generation unit 224. For specific functions of the units, refer to the foregoing embodiments, and details are not described herein.

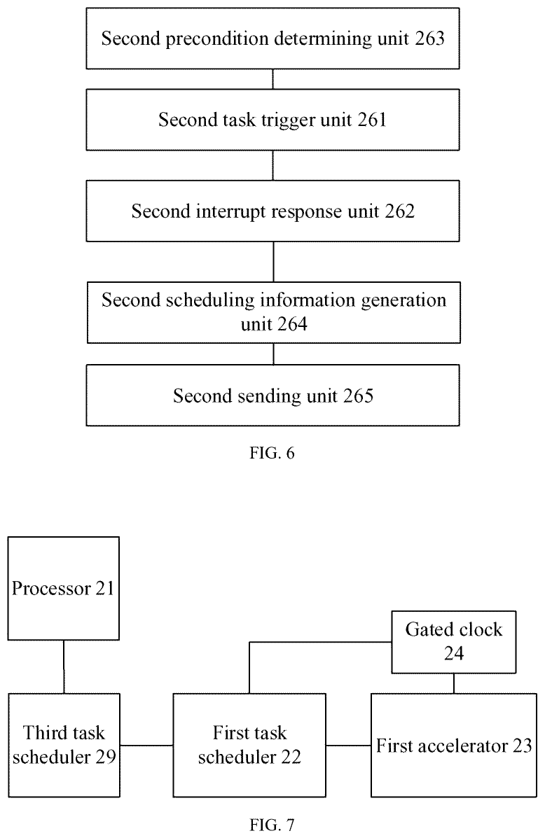

FIG. 6 is a schematic diagram of a structure of a system on chip supporting task scheduling according to still yet another exemplary embodiment of the present disclosure.

In some optional embodiments, as shown in FIG. 6, the second task scheduler 26 includes a second task trigger unit 261 and a second interrupt response unit 262. The second interrupt response unit 262 is coupled to the second task trigger unit 261.

The second task trigger unit 261 is respectively coupled to the processor 21, the first task scheduler 22, and the second accelerator 27, and is configured to: obtain the second scheduling information and the third scheduling information; determine, based on the second scheduling information, the first processing result of the first task anteriorly associated with the second task; determine second configuration information corresponding to the second task based on the third scheduling information; switch the gated clock 28 corresponding to the second accelerator 27 from the off state to the on state; and transmit the first processing result and the second configuration information to the second accelerator 27.

The second accelerator 27 is configured to obtain the first processing result and the second configuration information; execute the second task based on the first processing result and the second configuration information, to obtain a second processing result; and generate a second interrupt signal in response to completion of execution of the second task.

The second interrupt response unit 262 is configured to, in response to the second interrupt signal from the second accelerator 27, perform interrupt processing corresponding to the second interrupt signal, to obtain the second processing result; and control the gated clock 28 corresponding to the second accelerator 27 to switch from the on state to the off state.

The second configuration information corresponding to the second task is information to be configured into a configuration register of the second accelerator 27. The second configuration information may include the task type and the static parameter required by the second accelerator 27 to execute the second task. The first processing result serves as input data of the second accelerator.

In some optional embodiments, if the second task trigger unit 261 may determine the second configuration information corresponding to the second task based on the first processing result and the third scheduling information, the second configuration information may include the dynamic parameter and the static parameter required by the second accelerator 27 to execute the second task.

In some optional embodiments, the second task trigger unit 261 and the second interrupt response unit 262 are hardware circuits.

Specific functions of the second task trigger unit 261 and the second interrupt response unit 262 are similar to those of the first task trigger unit 221 and the first interrupt response unit 222, where differences are that these units depend on different scheduling information and schedule different accelerators. Details are not described herein.

In the embodiments of the present disclosure, the second task trigger unit determines, based on the second scheduling information, the first processing result of the first task anteriorly associated with the second task, and generates the second configuration information of the second task based on the third scheduling information. Implementing configuration of the second accelerator through hardware provides effective dynamic parameters and static parameters for the second accelerator to execute the second task. Moreover, by controlling the state switching of the gated clock of the second accelerator, it is ensured that the second accelerator can accurately execute the second task. Moreover, after the second accelerator completes the execution of the second task, the interrupt request of the second accelerator is responded to through the second interrupt response unit, avoiding interruption of a program being executed by the processor. Since the second interrupt response unit is a hardware circuit, compared with the processor 21 responding to the interrupt request through software, responding to the interrupt request through hardware can improve interrupt processing efficiency.

In some optional embodiments, as shown in FIG. 6, the second task scheduler 26 further includes a second precondition determining unit 263.

The second precondition determining unit 263 is respectively coupled to the processor 21 and the first task scheduler 22, and is configured to obtain the second scheduling information and the third scheduling information, and determine a trigger state of the second task based on the second scheduling information and the third scheduling information.

The second task trigger unit 261 is configured to: in response to the trigger state of the second task being triggered, obtain the second scheduling information and the third scheduling information; determine, based on the second scheduling information, the first processing result of the first task anteriorly associated with the second task; determine the second configuration information corresponding to the second task based on the third scheduling information; switch the gated clock 28 corresponding to the second accelerator 27 from the off state to the on state; and transmit the first processing result and the second configuration information to the second accelerator 27.

The second precondition determining unit 263 may obtain the second scheduling information from the first task scheduler 22, or read the second scheduling information from a storage space storing the second scheduling information. The second precondition determining unit 263 may obtain the third scheduling information from the processor 21, or read the third scheduling information from a storage space storing the third scheduling information. The trigger state of the second task indicates whether the second task can be triggered. If the second precondition determining unit 263 determines, based on the second scheduling information, the first task on which the second task depends, and determines based on the third scheduling information that the execution result of the first task is obtained, it is determined that the trigger state of the second task is triggered. If the second scheduling information is not obtained, indicating that the execution of the first task may not have been completed yet, it is determined that the trigger state of the second task is not triggered. After determining the trigger state of the second task, the second precondition determining unit 263 transmits the trigger state of the second task to the second task trigger unit 261. The second task trigger unit 261, in response to the trigger state of the second task being triggered, obtains the second scheduling information and the third scheduling information, and then schedules the second accelerator 27 based on the second scheduling information and the third scheduling information. For a specific operation of scheduling the second accelerator 27 based on the second scheduling information and the third scheduling information, refer to the foregoing embodiments.

In the embodiments of the present disclosure, the second precondition determining unit determines the trigger state of the second task based on the second scheduling information and the third scheduling information. The gated clock of the second accelerator is switched from the off state to the on state merely in a case where the trigger state of the second task is determined to be triggered, so that the second accelerator can execute the second task. Thus, accuracy of state switching timing of the gated clock can be further improved, so that the gated clock can be prevented from being prematurely switched from the off state to the on state, thereby further reducing dynamic power consumption of the second accelerator.

In some optional embodiments, as shown in FIG. 6, the second task scheduler 26 further includes a second scheduling information generation unit 264 and a second sending unit 265.

The second scheduling information generation unit 264 is coupled to the second interrupt response unit 262, and is configured to obtain the second processing result; and determine, based on the second processing result and the third scheduling information, a fourth task posteriorly associated with the second task, and a fourth task scheduler and fourth scheduling information corresponding to the fourth task.

The second sending unit 265 is coupled to the second scheduling information generation unit 264, and is configured to obtain the fourth scheduling information, and transmit the fourth scheduling information to the fourth task scheduler corresponding to the fourth task.

The fourth task scheduler is coupled to the second task scheduler 26, and is configured to control, based on the fourth scheduling information, a gated clock of a fourth accelerator to switch from an off state to an on state; and schedule the fourth accelerator to execute the fourth task.

Specific functions of the second scheduling information generation unit 264 and the second sending unit 265 are similar to those of the first scheduling information generation unit 224 and the first sending unit 225, and specific functions of the fourth task scheduler are similar to those of the second task scheduler 26. Details are not described herein.

In the embodiments of the present disclosure, after the first accelerator completes the execution of the first task, the second task scheduler is scheduled by the first task scheduler, and the second accelerator is scheduled by the second task scheduler to execute the second task. After the second accelerator completes the execution of the second task, the fourth task scheduler is scheduled by the second task scheduler, and the fourth accelerator is scheduled by the fourth task scheduler to execute the fourth task. Thus, cascaded scheduling of accelerators is implemented through hardware, which can reduce a quantity of interruptions to the processor 21. Moreover, compared with scheduling the accelerators through the processor 21, scheduling the accelerators through hardware can improve scheduling efficiency, and ensure that tasks are executed with high efficiency and low latency, thereby improving overall performance of the system on chip.

FIG. 7 is a schematic diagram of a structure of a system on chip supporting task scheduling according to a further exemplary embodiment of the present disclosure.

In some optional embodiments, on the basis of any one of the foregoing embodiments, the task set includes a plurality of tasks.

As shown in FIG. 7, the system on chip 20 further includes a third task scheduler 29 corresponding to the processor 21.

The processor 21 is coupled to the third task scheduler 29, and is configured to determine dependency relationships among the tasks in the task set; and determine, based on the task set and the dependency relationships, the first accelerator 23 and initial scheduling information corresponding to the first task.

The third task scheduler 29 is coupled to the first task scheduler 22, and is configured to obtain the initial scheduling information, and determine the first scheduling information based on the initial scheduling information.

The third task scheduler 29 is a hardware circuit with a scheduling function. The third task scheduler 29 is capable of scheduling task schedulers corresponding to accelerators. For example, the third task scheduler 29 may schedule the first task scheduler 22, the second task scheduler 26, and the fourth task scheduler.

In some optional embodiments, the processor 21 determines the task set and the dependency relationships among the tasks in the task set; and determines, based on the task set and the dependency relationships, the first accelerator 23 and the initial scheduling information corresponding to the first task. The task set and the dependency relationships among the tasks in the task set may be pre-compiled by the compiler and stored in a preset memory. When the task set needs to be executed, the processor 21 reads the task set and the dependency relationships among the tasks in the task set from the preset memory. The initial scheduling information is information required for scheduling the third task scheduler. The initial scheduling information may include, but is not limited to, at least one of the task information and associated tasks of the first task.

In some optional embodiments, the processor 21 may transmit the initial scheduling information in a form of a data packet. The data packet corresponding to the initial scheduling information may include a header portion and a data portion. The header portion may include one or more of a data length, a source, a destination, a task type, and an associated task. The source is the processor 21, and the destination is the third task scheduler 29. The associated tasks include the predecessor task and the successor task of the first task. The data portion may include the task identifier and the static parameter of the first task. The static parameter may include, but is not limited to, the storage address of the static computation data required for executing the first task.

In some optional embodiments, after determining the first accelerator 23 and the initial scheduling information corresponding to the first task, the processor 21 transmits the initial scheduling information to the third task scheduler 29. In response to obtaining the initial scheduling information, the third task scheduler 29 determines the first scheduling information based on the initial scheduling information. The third task scheduler 29 transmits the first scheduling information to the first task scheduler 22.

In the embodiments of the present disclosure, the first task scheduler corresponding to the first accelerator is scheduled by the third task scheduler corresponding to the processor, and operations originally performed by the processor are implemented through hardware, thereby further improving task scheduling efficiency.

In some optional embodiments, the processor 21 is configured to: determine anteriorly associated task information and posteriorly associated task information of the first task based on the task set and the dependency relationships; and determine the initial scheduling information based on the anteriorly associated task information and the posteriorly associated task information.

The anteriorly associated task information of the first task is task information about the predecessor task anteriorly associated with the first task. The posteriorly associated task information of the first task is task information about the successor task posteriorly associated with the first task. The initial scheduling information is determined based on the anteriorly associated task information and the posteriorly associated task information according to the data packet format.

In some optional embodiments, after execution of the last task in the task set is completed, the third task scheduler 29 may obtain an execution result of the last task from the task scheduler corresponding to the accelerator executing the last task. The execution result is a target processing result of the task set. The third task scheduler 29 may feed back the target processing result of the task set or a storage address of the target processing result to the processor 21. The processor 21 may obtain the target processing result, and execute other subsequent tasks based on the target processing result.

In some optional embodiments, if there is a preset task (or referred to as a special task) in the task set that cannot be accelerated by an accelerator, the third task scheduler 29 may report an execution result of a predecessor task on which the preset task depends to the processor 21, which executes the preset task.

In some optional embodiments, the processor 21 transmits initial scheduling information of the tasks in the task set to the third task scheduler 29. The third task scheduler 29 may first determine, based on the initial scheduling information, the first scheduling information for the first task to be executed this time, and then determine the first scheduling information for another task in a real-time manner based on the initial scheduling information of the another task when execution proceeds to the another task in the task set. Alternatively, the third task scheduler 29 may determine the first scheduling information of the tasks in the task set in a single pass, and transmit the first scheduling information of the tasks to the task schedulers corresponding to the tasks, respectively. The task schedulers may store the first scheduling information. Taking the second task scheduler 26 as an example, when any task scheduler serves as the second task scheduler being scheduled, the second task scheduler uses the stored first scheduling information as the third scheduling information for the second task, obtains the second scheduling information from the first task scheduler 22, and schedules, based on the second scheduling information and the third scheduling information, the second accelerator 27 to execute the second task.

In the embodiments of the present disclosure, the processor determines the associated task information of the first task based on the task set and the dependency relationships, determines the initial scheduling information based on the associated task information, and schedules the third task scheduler based on the initial scheduling information. The first task scheduler corresponding to the first accelerator is scheduled by the third task scheduler. Thus, the processor implements scheduling of a plurality of accelerators through a plurality of task schedulers, which can improve task scheduling efficiency, reduce task scheduling latency, and ensure real-time performance of task scheduling. Moreover, during the execution of the tasks in the task set, the task schedulers can directly schedule each other, and the accelerators can be directly scheduled by hardware schedulers to execute tasks, without requiring the processor to interrupt a main program, thereby reducing frequency at which the processor is interrupted by interrupt requests, and further improving processing performance of the system on chip.

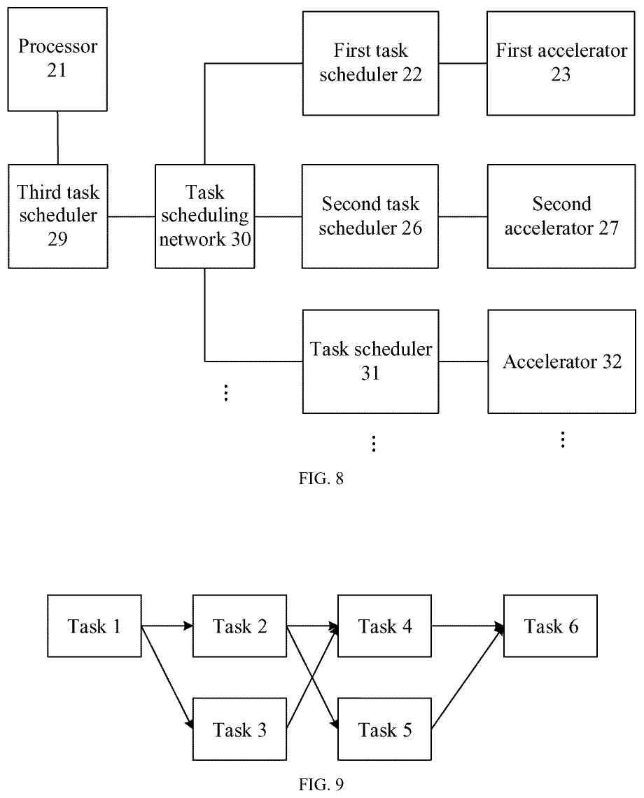

In some optional embodiments, FIG. 8 is a schematic diagram of a structure of a system on chip supporting task scheduling according to a still further exemplary embodiment of the present disclosure. As shown in FIG. 8, the task schedulers may be coupled to each other through a task scheduling network 30, and any two task schedulers may communicate through the task scheduling network 30. For example, the processor 21 sends the initial scheduling information to the third task scheduler 29. The third task scheduler 29 determines the first scheduling information based on the initial scheduling information, and sends the first scheduling information to the first task scheduler 22 through the task scheduling network 30. After scheduling the first accelerator 23 to execute the first task, the first task scheduler 22 determines, based on the first processing result and the first scheduling information, the second task posteriorly associated with the first task, and the second task scheduler and the second scheduling information corresponding to the second task; and transmits the second scheduling information to the second task scheduler 26 through the task scheduling network 30. After scheduling the second accelerator 27 to execute the second task, the second task scheduler 26 determines, based on the second processing result and the third scheduling information, the fourth task posteriorly associated with the second task, and the fourth task scheduler and the fourth scheduling information corresponding to the fourth task; and transmits the fourth scheduling information to the fourth task scheduler. The fourth task scheduler is, for example, a task scheduler 31 in FIG. 8. By analogy, this process continues until the tasks in the task set are all executed, and a final target processing result corresponding to the task set is obtained.

In some optional embodiments, FIG. 9 is a schematic diagram of a task set according to an exemplary embodiment of the present disclosure. As shown in FIG. 9, the task set includes 6 tasks, that is, Task 1, Task 2, . . . , and Task 6. An arrow direction indicates a task scheduling flow, and also represents dependency relationships between the tasks. Task 2 and Task 3 depend on Task 1. In other words, Task 2 and Task 3 can be executed only after execution of Task 1 is completed. Task 4 depends on Task 2 and Task 3. Task 5 depends on Task 2. Task 6 depends on Task 4 and Task 5. There is no dependency relationship between the Task 2 and Task 3. After the execution of the Task 1 is completed, Task 2 and Task 3 may be executed in parallel or in any order, which is not specifically limited. The processor 21 may determine the first accelerator 23 and the initial scheduling information corresponding to the first task based on the tasks in the task set, the dependency relationships, and the tasks that can be executed by the accelerators. The processor 21 communicates with the task schedulers corresponding to the accelerators through the third task scheduler 29, and then schedules the accelerators through the task schedulers corresponding to the accelerators to execute the tasks. For a specific scheduling flow, refer to the foregoing embodiments, and details are not described herein.

In related technologies, the accelerators are scheduled by the processor. For each task in the task set, the processor is required to determine configuration information for the task; and configure, based on the configuration information, parameters required by the accelerator to execute the task. After completing execution of the task, the accelerator sends an interrupt signal to the processor. The processor, in response to the interrupt signal from the accelerator, interrupts the main program being executed, to execute an interrupt processing program corresponding to the interrupt signal, to obtain an execution result obtained by the accelerator executing the task. The processor determines, based on the execution result of the task, configuration information for a next task that depends on the task, and calls the accelerator corresponding to the next task to execute the next task. In this way, during execution of a plurality of tasks in the task set, the main program executed by the processor is interrupted a plurality of times, and the processor schedules the accelerators through software and responds to interrupt requests from the accelerators through software, resulting in low task scheduling efficiency and large task execution latency. Moreover, the accelerators are in a working state when executing tasks and in an idle state when not executing tasks. Although power consumption of the accelerators in the idle state is lower than that in the working state, there is still a certain amount of power consumption resulting in relatively high dynamic power consumption of the accelerators.

According to the system on chip supporting task scheduling provided in the embodiments of the present disclosure, the processor schedules the task schedulers corresponding to at least one accelerator through the third task scheduler, and then schedules the accelerators through the task schedulers corresponding to the accelerators to execute the tasks. The task schedulers are implemented based on hardware. Compared with scheduling the accelerators through processor software, in the embodiments of the present disclosure, scheduling the accelerators through hardware can control task scheduling at the nanosecond level, thereby improving task scheduling efficiency and reducing task processing latency. Moreover, the gated clock of the accelerator is turned on merely when the accelerator needs to be scheduled to execute the task, so that on or off of the gated clock is controlled at a task level, thereby avoiding or reducing duration of the accelerator being in the idle state, and significantly reducing the dynamic power consumption of the accelerator. In this case, since the dynamic power consumption accounts for a relatively large proportion in the system on chip, the total power consumption of the system on chip can be reduced.

The foregoing embodiments of the present disclosure may be implemented separately or in any combination without conflict. This may be specifically set according to actual requirements, and is not limited in the present disclosure.

### Exemplary Method

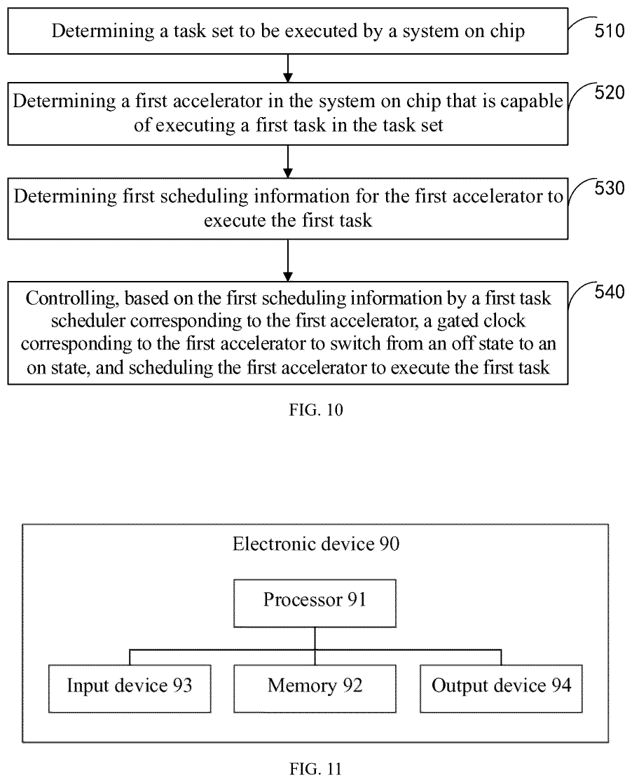

FIG. 10 is a schematic flowchart of a task scheduling method according to an exemplary embodiment of the present disclosure. The task scheduling method provided in this embodiment of the present disclosure may be implemented by the system on chip supporting task scheduling provided in any one of the foregoing embodiments. As shown in FIG. 10, the task scheduling method provided in this embodiment of the present disclosure may include the following steps.
Step 510: Determining a task set to be executed by a system on chip.
Step 520: Determining a first accelerator in the system on chip that is capable of executing a first task in the task set.
Step 530: Determining first scheduling information for the first accelerator to execute the first task.
Step 540: Controlling, based on the first scheduling information by a first task scheduler corresponding to the first accelerator, a gated clock corresponding to the first accelerator to switch from an off state to an on state, and scheduling the first accelerator to execute the first task.

In some optional embodiments, step 540 of controlling, based on the first scheduling information by a first task scheduler corresponding to the first accelerator, a gated clock corresponding to the first accelerator to switch from an off state to an on state, and scheduling the first accelerator to execute the first task includes:
obtaining the first scheduling information by a first task trigger unit in the first task scheduler; determining first configuration information corresponding to the first task by the first task trigger unit based on the first scheduling information; switching, by the first task trigger unit, the gated clock corresponding to the first accelerator from the off state to the on state; transmitting the first configuration information to the first accelerator by the first task trigger unit; executing the first task by the first accelerator based on the first configuration information, to obtain a first processing result corresponding to the first task; writing the first processing result into a first memory by the first accelerator; generating a first interrupt signal by the first accelerator in response to completion of execution of the first task; performing, by a first interrupt response unit in the first task scheduler, interrupt processing corresponding to the first interrupt signal in response to the first interrupt signal from the first accelerator, and reading the first processing result from the first memory; and controlling, by the first interrupt response unit, the gated clock corresponding to the first accelerator to switch from the on state to the off state.

In some optional embodiments, before the obtaining the first scheduling information by a first task trigger unit in the first task scheduler, the method further includes: obtaining the first scheduling information by a first precondition determining unit in the first task scheduler, and determining a trigger state of the first task by the first precondition determining unit based on the first scheduling information.

The obtaining the first scheduling information by a first task trigger unit in the first task scheduler includes:
obtaining the first scheduling information by the first task trigger unit in response to the trigger state of the first task being triggered.

In some optional embodiments, after the performing, by a first interrupt response unit in the first task scheduler, interrupt processing corresponding to the first interrupt signal in response to the first interrupt signal from the first accelerator, and reading the first processing result from the first memory, the method further includes:
obtaining the first processing result by a first scheduling information generation unit in the first task scheduler; determining, by the first scheduling information generation unit based on the first processing result and the first scheduling information, a second task posteriorly associated with the first task, and a second task scheduler and second scheduling information corresponding to the second task; obtaining the second scheduling information by a first sending unit in the first task scheduler, and transmitting the second scheduling information to the second task scheduler by the first sending unit, where the second task scheduler is a task scheduler corresponding to a second accelerator capable of executing the second task; and controlling, by the second task scheduler based on the second scheduling information, a gated clock corresponding to the second accelerator to switch from an off state to an on state, and scheduling, by the second task scheduler, the second accelerator to execute the second task.

In some optional embodiments, before the scheduling, by the second task scheduler, the second accelerator to execute the second task, the method further includes: determining third scheduling information for the second accelerator to execute the second task.

The scheduling, by the second task scheduler, the second accelerator to execute the second task includes:
obtaining the second scheduling information and the third scheduling information by the second task scheduler; controlling, by the second task scheduler based on the second scheduling information and the third scheduling information, the gated clock corresponding to the second accelerator to switch from the off state to the on state; and scheduling, by the second task scheduler based on the second scheduling information and the third scheduling information, the second accelerator to execute the second task.

In some optional embodiments, the controlling, by the second task scheduler based on the second scheduling information, a gated clock corresponding to the second accelerator to switch from an off state to an on state, and scheduling, by the second task scheduler, the second accelerator to execute the second task includes:
obtaining the second scheduling information and the third scheduling information by a second task trigger unit in the second task scheduler; determining, by the second task trigger unit based on the second scheduling information, the first processing result of the first task anteriorly associated with the second task; determining, by the second task trigger unit based on the third scheduling information, second configuration information corresponding to the second task; switching, by the second task trigger unit, the gated clock corresponding to the second accelerator from the off state to the on state; and transmitting, by the second task trigger unit, the first processing result and the second configuration information to the second accelerator;
obtaining the first processing result and the second configuration information by the second accelerator; executing the second task by the second accelerator based on the first processing result and the second configuration information, to obtain a second processing result; and generating a second interrupt signal in response to completion of execution of the second task; and
performing interrupt processing corresponding to the second interrupt signal by a second interrupt response unit in the second task scheduler in response to the second interrupt signal from the second accelerator, to obtain the second processing result; and controlling, by the second interrupt response unit, the gated clock corresponding to the second accelerator to switch from the on state to the off state.

In some optional embodiments, before the obtaining the second scheduling information and the third scheduling information by a second task trigger unit in the second task scheduler, the method further includes:
obtaining, by a second precondition determining unit in the second task scheduler, the second scheduling information and the third scheduling information, and determining a trigger state of the second task based on the second scheduling information and the third scheduling information; and
the obtaining the second scheduling information and the third scheduling information by a second task trigger unit in the second task scheduler includes: obtaining the second scheduling information and the third scheduling information by the second task trigger unit in response to the trigger state of the second task being triggered; determining, by the second task trigger unit based on the second scheduling information, the first processing result of the first task anteriorly associated with the second task; determining, by the second task trigger unit based on the third scheduling information, second configuration information corresponding to the second task; switching, by the second task trigger unit, the gated clock corresponding to the second accelerator from the off state to the on state; and transmitting, by the second task trigger unit, the first processing result and the second configuration information to the second accelerator.

In some optional embodiments, the task set includes a plurality of tasks.

Step 530 of determining first scheduling information for the first accelerator to execute the first task includes:
determining dependency relationships among the tasks in the task set, and determining initial scheduling information corresponding to the first task based on the task set and the dependency relationships; obtaining the initial scheduling information by a third task scheduler; and determining the first scheduling information by the third task scheduler based on the initial scheduling information.

In some optional embodiments, the determining initial scheduling information corresponding to the first task based on the task set and the dependency relationships includes:
determining anteriorly associated task information and posteriorly associated task information of the first task based on the task set and the dependency relationships; and determining the initial scheduling information based on the anteriorly associated task information and the posteriorly associated task information.

For specific functions of the task schedulers, the units, and the accelerators in the foregoing embodiments, reference may be made to the exemplary system section described above, and details are not described herein.

The foregoing embodiments of the present disclosure may be implemented separately or in any combination without conflict. This may be specifically set according to actual requirements, and is not limited in the present disclosure.

For beneficial technical effects corresponding to the exemplary embodiments of this method, reference may be made to the corresponding beneficial technical effects in the Exemplary system section described above, and details are not described herein again.

Any task scheduling method provided in the embodiments of the present disclosure may be implemented by any suitable electronic device with a data processing capability, including but not limited to a terminal device, a server, and other electronic devices. Alternatively, any task scheduling and method provided in the embodiments of the present disclosure may be implemented by a processor. For example, the processor implements any task scheduling and method described in the embodiments of the present disclosure by invoking corresponding instructions stored in a memory. Details are not described below.

### Exemplary electronic device

FIG. 11 is a diagram of a structure of an electronic device according to an embodiment of the present disclosure. The electronic device includes at least one processor 91 and a memory 92.

The processor 91 may be a central processing unit (CPU) or another form of processing unit having a data processing capability and/or an instruction execution capability, and may control another component in the electronic device 90 to perform a desired function.

The memory 92 may include one or more computer program products, which may include various forms of computer readable storage media, such as a volatile memory and/or a non-volatile memory. The volatile memory may include, for example, a random access memory (RAM) and/or a cache. The non-volatile memory may include, for example, a read-only memory (ROM), a hard disk, or a flash memory. One or more computer program instructions may be stored on the computer readable storage medium. The processor 91 may run the one or more computer program instructions to implement the task scheduling method according to various embodiments of the present disclosure that are described above and/or other desired functions.

In an example, the electronic device 90 may further include an input device 93 and an output device 94. These components are interconnected through a bus system and/or other forms of connection mechanisms (not shown).

The input device 93 may further include a touch screen, a microphone, and various sensors.

The output device 94 may output various information to the outside, and may include, for example, a display, a speaker, a communication network, and a remote output device connected to the communication network.

Certainly, for simplicity, FIG. 11 shows only some of the components in the electronic device 90 that are related to the present disclosure, and components such as a bus and an input/output interface are omitted. In addition, according to specific applications, the electronic device 90 may also include any other appropriate components.

In some optional embodiments, embodiments of the present disclosure further provide an electronic device, which includes the system on chip according to any one of the foregoing embodiments.

Exemplary computer program product and computer readable storage medium

In addition to the foregoing methods and devices, embodiments of the present disclosure may also provide a computer program product including computer program instructions that, when run by a processor, cause the processor to perform the steps, of the task scheduling method according to the embodiments of the present disclosure, that are described in the “Exemplary method” section described above.

The computer program product may be program code, written with one or any combination of a plurality of programming languages, that is configured to perform the operations in the embodiments of the present disclosure. The programming languages include an object-oriented programming language such as Java or C++, and further include a conventional procedural programming language such as a “C” language or a similar programming language. The program code may be entirely or partially executed on a user computing device, executed as an independent software package, partially executed on the user computing device and partially executed on a remote computing device, or entirely executed on the remote computing device or a server.

In addition, the embodiments of the present disclosure may further relate to a computer readable storage medium, on which computer program instructions are stored. The computer program instructions, when run by the processor, cause the processor to perform the steps, of the task scheduling method according to the embodiments of the present disclosure, that are described in the “Exemplary method” section described above.

The computer readable storage medium may be one readable medium or any combination of a plurality of readable media. The readable medium may be a readable signal medium or a readable storage medium. The readable storage medium includes for example, but is not limited to, electrical, magnetic, optical, electromagnetic, infrared, or semiconductor systems, apparatuses, or devices, or any combination of the above. More specific examples (a non-exhaustive list) of the readable storage medium include: an electrical connection with one or more conducting wires, a portable disk, a hard disk, a random access memory (RAM), a read-only memory (ROM), an erasable programmable read-only memory (EPROM or a flash memory), an optical fiber, a portable compact disc read-only memory (CD-ROM), an optical storage device, a magnetic storage device, or any suitable combination of the above.

Basic principles of the present disclosure are described above in combination with specific embodiments. However, advantages, superiorities, and effects mentioned in the present disclosure are merely examples rather than limitations, and it cannot be considered that these advantages, superiorities, and effects are necessary for the embodiments of the present disclosure. In addition, the specific details disclosed above are merely for examples and for ease of understanding, rather than for limitations. The details described above do not limit the present disclosure to necessarily adopting the foregoing specific details for implementation.

A person skilled in the art may make various modifications and variations to the present disclosure without departing from the spirit and the scope of this application. In this way, if these modifications and variations of this application fall within the scope of the claims and equivalent technologies of the claims of the present disclosure, the present disclosure also intends to include these modifications and variations.

What is claimed is:

1. A system on chip supporting task scheduling, comprising:
a processor, configured to determine a task set to be executed by the system on chip, determine a first accelerator in the system on chip that is capable of executing a first task in the task set, and determine first scheduling information for the first accelerator to execute the first task; and
a first task scheduler for scheduling the first accelerator, configured to obtain the first scheduling information from the processor; control, based on the first scheduling information, a gated clock corresponding to the first accelerator to switch from an off state to an on state; and schedule the first accelerator to execute the first task.

2. The system on chip according to claim 1, wherein the first task scheduler comprises a first task trigger unit and a first interrupt response unit;
the first task trigger unit is configured to obtain the first scheduling information, determine first configuration information corresponding to the first task based on the first scheduling information, switch the gated clock corresponding to the first accelerator from the off state to the on state, and transmit the first configuration information to the first accelerator;
the first accelerator is configured to execute the first task based on the first configuration information to obtain a first processing result corresponding to the first task, write the first processing result into a first memory, and generate a first interrupt signal in response to completion of execution of the first task; and
the first interrupt response unit is configured to, in response to the first interrupt signal from the first accelerator, perform interrupt processing corresponding to the first interrupt signal, read the first processing result from the first memory, and control the gated clock corresponding to the first accelerator to switch from the on state to the off state.

3. The system on chip according to claim 2, wherein the first task scheduler further comprises:
a first precondition determining unit, configured to obtain the first scheduling information, and determine a trigger state of the first task based on the first scheduling information; and
the first task trigger unit is configured to, in response to the trigger state of the first task being triggered, obtain the first scheduling information, determine the first configuration information based on the first scheduling information, switch the gated clock corresponding to the first accelerator from the off state to the on state, and transmit the first configuration information to the first accelerator.

4. The system on chip according to claim 2, wherein the first task scheduler further comprises:
a first scheduling information generation unit, configured to obtain the first processing result; and determine, based on the first processing result and the first scheduling information, a second task posteriorly associated with the first task, and a second task scheduler and second scheduling information corresponding to the second task;
a first sending unit, configured to obtain the second scheduling information, and transmit the second scheduling information to the second task scheduler, wherein the second task scheduler is a task scheduler corresponding to a second accelerator capable of executing the second task; and
the second task scheduler is configured to control, based on the second scheduling information, a gated clock corresponding to the second accelerator to switch from an off state to an on state, and schedule the second accelerator to execute the second task.

5. The system on chip according to claim 4, wherein the processor is further configured to determine third scheduling information for the second accelerator to execute the second task; and
the second task scheduler is configured to obtain the second scheduling information and the third scheduling information; control, based on the second scheduling information and the third scheduling information, the gated clock corresponding to the second accelerator to switch from the off state to the on state; and schedule the second accelerator to execute the second task.

6. The system on chip according to claim 5, wherein the second task scheduler comprises a second task trigger unit and a second interrupt response unit;
the second task trigger unit is configured to: obtain the second scheduling information and the third scheduling information; determine, based on the second scheduling information, the first processing result of the first task anteriorly associated with the second task; determine second configuration information corresponding to the second task based on the third scheduling information; switch the gated clock corresponding to the second accelerator from the off state to the on state; and transmit the first processing result and the second configuration information to the second accelerator;
the second accelerator is configured to obtain the first processing result and the second configuration information; execute the second task based on the first processing result and the second configuration information, to obtain a second processing result; and generate a second interrupt signal in response to completion of execution of the second task; and
the second interrupt response unit is configured to, in response to the second interrupt signal from the second accelerator, perform interrupt processing corresponding to the second interrupt signal, to obtain the second processing result; and control the gated clock corresponding to the second accelerator to switch from the on state to the off state.

7. The system on chip according to claim 6, wherein the second task scheduler further comprises:
a second precondition determining unit, configured to obtain the second scheduling information and the third scheduling information, and determine a trigger state of the second task based on the second scheduling information and the third scheduling information; and
the second task trigger unit is configured to: in response to the trigger state of the second task being triggered, obtain the second scheduling information and the third scheduling information; determine, based on the second scheduling information, the first processing result of the first task anteriorly associated with the second task; determine the second configuration information corresponding to the second task based on the third scheduling information; switch the gated clock corresponding to the second accelerator from the off state to the on state; and
transmit the first processing result and the second configuration information to the second accelerator.

8. The system on chip according to claim 1, wherein the task set comprises a plurality of tasks;
the system on chip further comprises a third task scheduler corresponding to the processor;
the processor is configured to determine dependency relationships among the tasks in the task set, and determine, based on the task set and the dependency relationships, the first accelerator and initial scheduling information corresponding to the first task; and
the third task scheduler is configured to obtain the initial scheduling information, and determine the first scheduling information based on the initial scheduling information.

9. The system on chip according to claim 8, wherein the processor is configured to:
determine anteriorly associated task information and posteriorly associated task information of the first task based on the task set and the dependency relationships; and
determine the initial scheduling information based on the anteriorly associated task information and the posteriorly associated task information.

10. A task scheduling method, comprising:
determining a task set to be executed by a system on chip;
determining a first accelerator in the system on chip that is capable of executing a first task in the task set;
determining first scheduling information for the first accelerator to execute the first task; and
controlling, based on the first scheduling information by a first task scheduler corresponding to the first accelerator, a gated clock corresponding to the first accelerator to switch from an off state to an on state, and scheduling the first accelerator to execute the first task.

11. The task scheduling method according to claim 10, wherein the controlling, based on the first scheduling information by a first task scheduler corresponding to the first accelerator, a gated clock corresponding to the first accelerator to switch from an off state to an on state, and scheduling the first accelerator to execute the first task comprises:
obtaining the first scheduling information by a first task trigger unit in the first task scheduler; determining first configuration information corresponding to the first task by the first task trigger unit based on the first scheduling information; switching, by the first task trigger unit, the gated clock corresponding to the first accelerator from the off state to the on state; transmitting the first configuration information to the first accelerator by the first task trigger unit; executing the first task by the first accelerator based on the first configuration information, to obtain a first processing result corresponding to the first task; writing the first processing result into a first memory by the first accelerator; generating a first interrupt signal by the first accelerator in response to completion of execution of the first task; performing, by a first interrupt response unit in the first task scheduler, interrupt processing corresponding to the first interrupt signal in response to the first interrupt signal from the first accelerator, and reading the first processing result from the first memory; and controlling, by the first interrupt response unit, the gated clock corresponding to the first accelerator to switch from the on state to the off state.

12. The task scheduling method according to claim 11, wherein, before the obtaining the first scheduling information by a first task trigger unit in the first task scheduler, the method further comprises:
obtaining the first scheduling information by a first precondition determining unit in the first task scheduler, and determining a trigger state of the first task by the first precondition determining unit based on the first scheduling information.

13. The task scheduling method according to claim 11, wherein the obtaining the first scheduling information by a first task trigger unit in the first task scheduler comprises:
obtaining the first scheduling information by the first task trigger unit in response to the trigger state of the first task being triggered.

14. The task scheduling method according to claim 11, wherein after the performing, by a first interrupt response unit in the first task scheduler, interrupt processing corresponding to the first interrupt signal in response to the first interrupt signal from the first accelerator, and reading the first processing result from the first memory, the method further comprises:
obtaining the first processing result by a first scheduling information generation unit in the first task scheduler; determining, by the first scheduling information generation unit based on the first processing result and the first scheduling information, a second task posteriorly associated with the first task, and a second task scheduler and second scheduling information corresponding to the second task; obtaining the second scheduling information by a first sending unit in the first task scheduler, and transmitting the second scheduling information to the second task scheduler by the first sending unit, wherein the second task scheduler is a task scheduler corresponding to a second accelerator capable of executing the second task; and controlling, by the second task scheduler based on the second scheduling information, a gated clock corresponding to the second accelerator to switch from an off state to an on state, and scheduling, by the second task scheduler, the second accelerator to execute the second task.

15. The task scheduling method according to claim 14, wherein before the scheduling, by the second task scheduler, the second accelerator to execute the second task, the method further comprises:
determining third scheduling information for the second accelerator to execute the second task.

16. A non-transitory computer readable storage medium, wherein the storage medium stores a computer program, and the computer program is executed by a processor to implement a task scheduling method comprising:
determining a task set to be executed by a system on chip;
determining a first accelerator in the system on chip that is capable of executing a first task in the task set;
determining first scheduling information for the first accelerator to execute the first task; and
controlling, based on the first scheduling information by a first task scheduler corresponding to the first accelerator, a gated clock corresponding to the first accelerator to switch from an off state to an on state, and scheduling the first accelerator to execute the first task.

17. The non-transitory computer readable storage medium according to claim 16, wherein the storage medium stores a computer program, and the computer program is executed by a processor to implement the task scheduling method further comprising:
wherein the controlling, based on the first scheduling information by a first task scheduler corresponding to the first accelerator, a gated clock corresponding to the first accelerator to switch from an off state to an on state, and scheduling the first accelerator to execute the first task comprises:
obtaining the first scheduling information by a first task trigger unit in the first task scheduler; determining first configuration information corresponding to the first task by the first task trigger unit based on the first scheduling information; switching, by the first task trigger unit, the gated clock corresponding to the first accelerator from the off state to the on state; transmitting the first configuration information to the first accelerator by the first task trigger unit; executing the first task by the first accelerator based on the first configuration information, to obtain a first processing result corresponding to the first task; writing the first processing result into a first memory by the first accelerator; generating a first interrupt signal by the first accelerator in response to completion of execution of the first task; performing, by a first interrupt response unit in the first task scheduler, interrupt processing corresponding to the first interrupt signal in response to the first interrupt signal from the first accelerator, and reading the first processing result from the first memory; and controlling, by the first interrupt response unit, the gated clock corresponding to the first accelerator to switch from the on state to the off state.

18. An electronic device, wherein the electronic device comprises:
a system on chip supporting task scheduling, wherein the system on chip comprises:
a processor, configured to determine a task set to be executed by the system on chip, determine a first accelerator in the system on chip that is capable of executing a first task in the task set, and determine first scheduling information for the first accelerator to execute the first task; and
a first task scheduler for scheduling the first accelerator, configured to obtain the first scheduling information from the processor; control, based on the first scheduling information, a gated clock corresponding to the first accelerator to switch from an off state to an on state; and schedule the first accelerator to execute the first task.

19. An electronic device, wherein the electronic device comprises:
a processor; and
a memory, configured to store instructions executable by the processor, wherein
the processor is configured to read the executable instructions from the memory, and execute the instructions to implement a task scheduling comprising:
determining a task set to be executed by a system on chip;
determining a first accelerator in the system on chip that is capable of executing a first task in the task set;
determining first scheduling information for the first accelerator to execute the first task; and
controlling, based on the first scheduling information by a first task scheduler corresponding to the first accelerator, a gated clock corresponding to the first accelerator to switch from an off state to an on state, and scheduling the first accelerator to execute the first task.

20. The electronic device according to claim 19, wherein the processor is configured to read the executable instructions from the memory, and execute the instructions to implement the task scheduling method further comprising:
wherein the controlling, based on the first scheduling information by a first task scheduler corresponding to the first accelerator, a gated clock corresponding to the first accelerator to switch from an off state to an on state, and scheduling the first accelerator to execute the first task comprises:
obtaining the first scheduling information by a first task trigger unit in the first task scheduler; determining first configuration information corresponding to the first task by the first task trigger unit based on the first scheduling information; switching, by the first task trigger unit, the gated clock corresponding to the first accelerator from the off state to the on state; transmitting the first configuration information to the first accelerator by the first task trigger unit; executing the first task by the first accelerator based on the first configuration information, to obtain a first processing result corresponding to the first task; writing the first processing result into a first memory by the first accelerator; generating a first interrupt signal by the first accelerator in response to completion of execution of the first task; performing, by a first interrupt response unit in the first task scheduler, interrupt processing corresponding to the first interrupt signal in response to the first interrupt signal from the first accelerator, and reading the first processing result from the first memory; and controlling, by the first interrupt response unit, the gated clock corresponding to the first accelerator to switch from the on state to the off state.
